(19) United States
(12) Patent Application Publication
(10) Pub. No.: US 2025/0360419 A1
(43) Pub. Date: Nov. 27, 2025

(54) SYSTEM AND METHOD FOR UTILIZING KNOWLEDGE STRUCTURE TO ADD NEW GAME FEATURES IN A GAMING ENVIRONMENT

(71) Applicant: 2hr Learning, Inc., Austin, TX (US)

(72) Inventor: Isaac Squires, Hesperus, CO (US)

(73) Assignee: 2hr Learning, Inc., Austin, TX (US)

(21) Appl. No.: 19/215,331

(22) Filed: May 22, 2025

Related U.S. Application Data
(60) Provisional application No. 63/652,142, filed on May 27, 2024.

(51) Int. Cl. A63F 13/69

(52) U.S. Cl. CPC A63F 13/69

(57) ABSTRACT

A method is disclosed for guiding an Artificial Intelligence (AI) engine to unlock new features within an online gaming platform based on a user's academic progress. The method includes providing a user interface that enables interaction with the gaming platform and creating a base knowledge structure stored within the user's profile, representing skills and knowledge acquired. As the user achieves educational milestones, the knowledge structure is incrementally increased in height, with each level signifying a corresponding advancement in learning. A prompt is generated to guide the AI engine in unlocking new game features when the knowledge structure reaches predefined thresholds. The prompt is transmitted to the AI engine, which then activates the new features within the gaming environment during gameplay. This approach incentivizes academic achievement by linking educational progress to enhanced in-game experiences, thereby promoting learning through interactive gaming.

### CROSS-REFERENCE TO RELATED APPLICATION

This application claims the benefit under 35 U.S.C. § 119(e) and 37 C.F.R. § 1.78 of U.S. Provisional Application Nos. 63/651,224, filed May 23, 2024 and 63/652,142, filed May 27, 2024, which are both incorporated by reference in their entireties.

This application incorporates by reference U.S. patent application Ser. No. 19/215,325 in its entirety.

### FIELD OF THE INVENTION

The present invention relates in general to the field of electronics, and more specifically to an online gaming platform incorporating the knowledge structure, where the increase in height of the knowledge structure unlocks new areas of the game based on the mastery level of the user on different educational concepts.

### BACKGROUND OF THE INVENTION

Educational platforms have undergone numerous transformations to track the progress of learners. The educational platforms provide text, audio, and video-based lessons for learners to learn virtually at their own pace and convenience. Moreover, the educational platforms offer different types of questions in assessments to practice. The incorporation of different interactive features within an educational platform enhances the engagement of the learners.

Historically the educational platform has relied on different metrics such as progress bars, points, in-game currency, or badges to indicate the progress of the learners. These indicators provide a visual representation of the learner's progress within a particular domain, primarily focusing on task completion rather than providing a meaningful connection with learning objectives.

Consequently, the learners may complete a lesson without completely covering all the fundamental topics of that lesson. The traditional educational platforms may help learners master a concept but still fail to help them understand thoroughly the concepts behind the questions answered incorrectly. The students might attempt the questions, however, the understanding behind the concepts may still seem very superficial thus creating a knowledge gap.

### SUMMARY

In embodiments, a system and a method transforms a computer display into a dynamic knowledge structure representing hierarchical knowledge levels, achievements, and prerequisites that represent foundational knowledge to mastery of a knowledge concept. The system and execute code to cause a computer system to perform operations that include:
accessing knowledge data that defines knowledge levels, wherein the knowledge levels represent a sequence of knowledge levels to reach mastery levels;
transforming an electronic display to visually present the knowledge levels as interconnected, layers of physical object representations, wherein the interconnections represent the prerequisite knowledge levels;
accessing personnel knowledge completion levels of a student;
causing appearances of the knowledge level physical objects representation that correspond to respective knowledge levels to be differentiated based on a state of mastery of corresponding knowledge levels by the student that inform the student of progress towards knowledge concept mastery and gaps in the foundational knowledge of the student of the knowledge concept mastery; and
adding interconnected, layers of physical object representations as the student reaches mastery of a knowledge level at a highest one of the layers.

### BRIEF DESCRIPTION OF THE DRA WINGS

The systems and methods described herein may be better understood, and their numerous objects, features, and advantages are made apparent to those skilled in the art by referencing exemplary embodiments depicted in the accompanying figures. The use of the same reference number throughout the several figures designates a like or similar element.

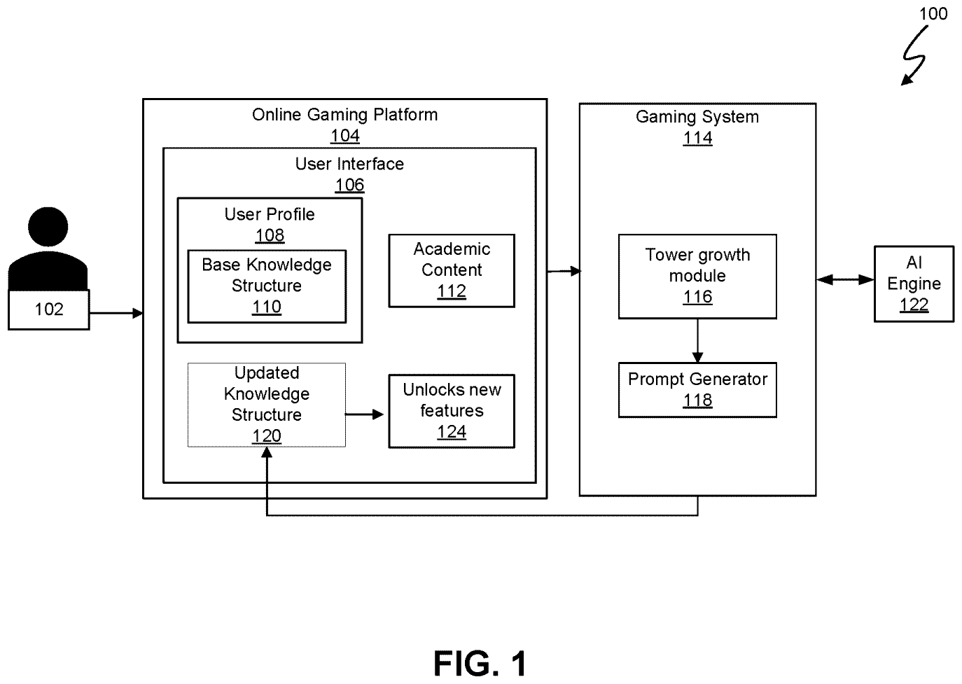

FIG. 1 depicts an exemplary online gaming environment powered by artificial intelligence (AI).

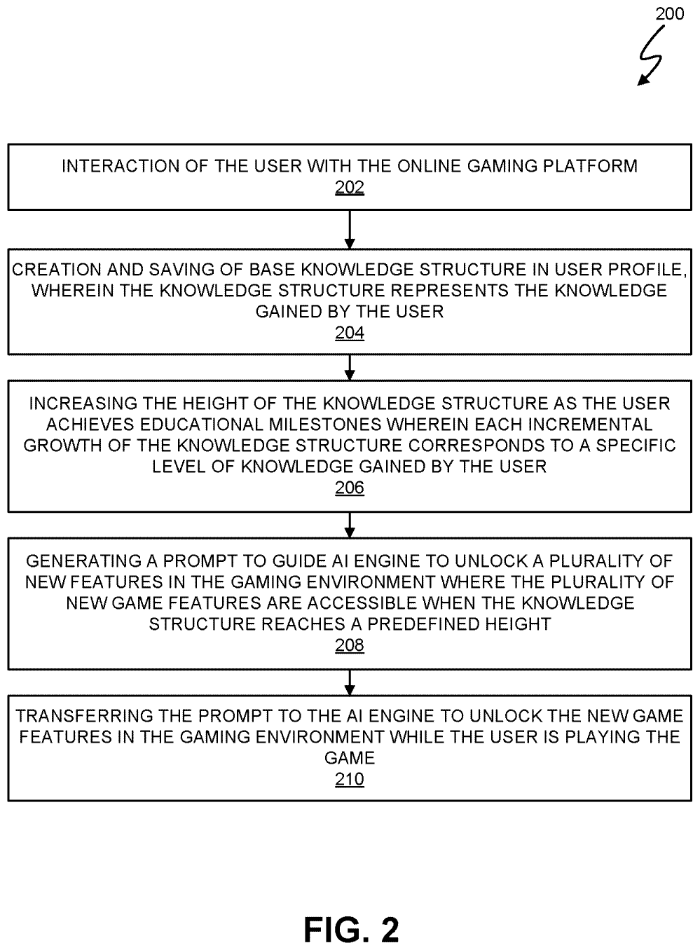

FIG. 2 depicts an exemplary online gaming environment process utilized by the online gaming environment.

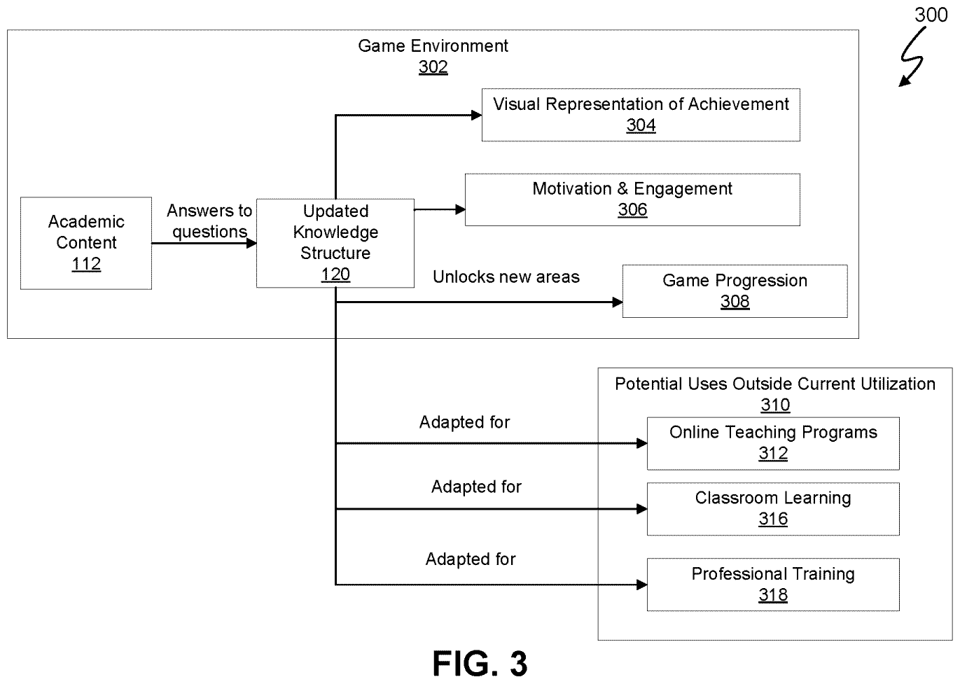

FIG. 3 depicts a relationship generation process between an updated knowledge structure and the online gaming environment, which is an embodiment of the online gaming environment process of FIG. 2.

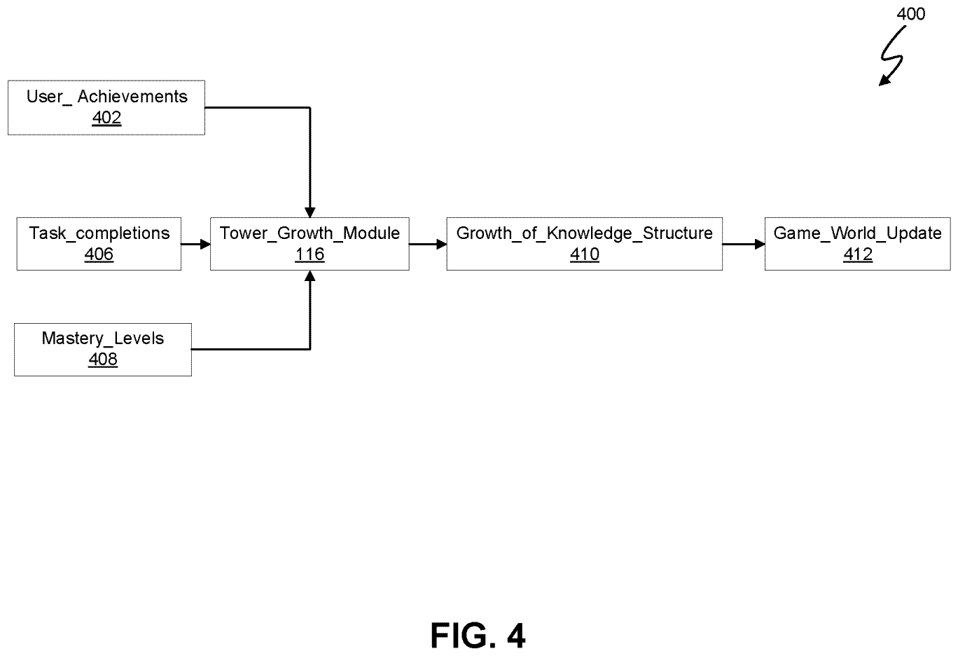

FIG. 4 depicts a game world update process, which is an embodiment of the online gaming environment process of FIG. 2.

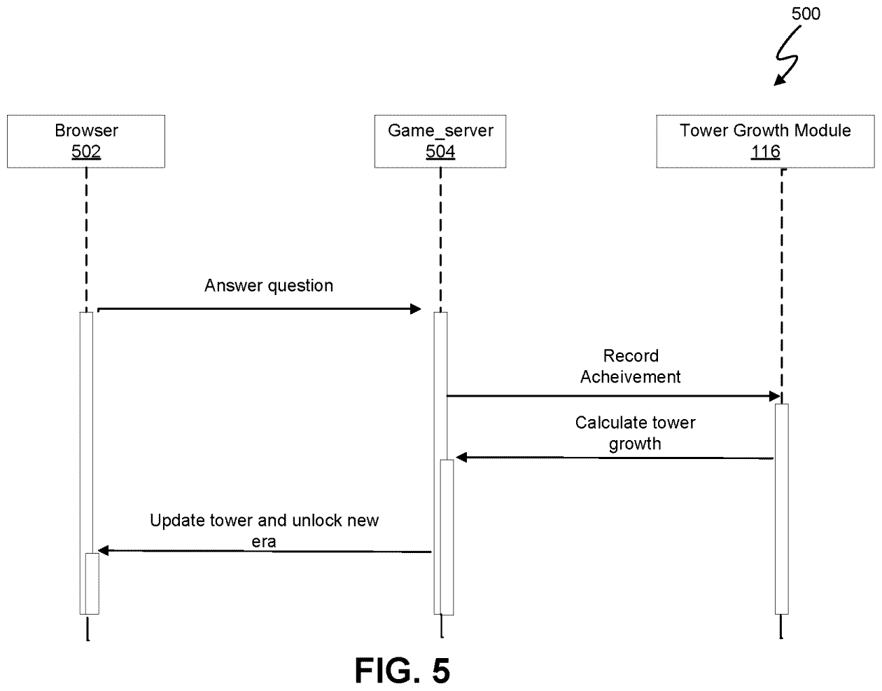

FIG. 5 depicts the sequence diagram for unlocking new features within the online gaming platform.

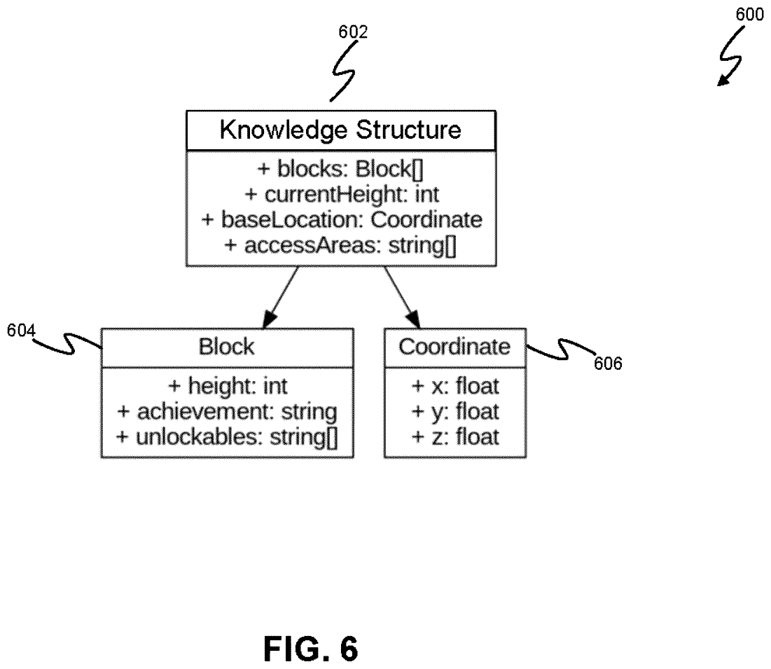

FIG. 6 depicts a data structure for the knowledge structure which represents the knowledge progress of the user.

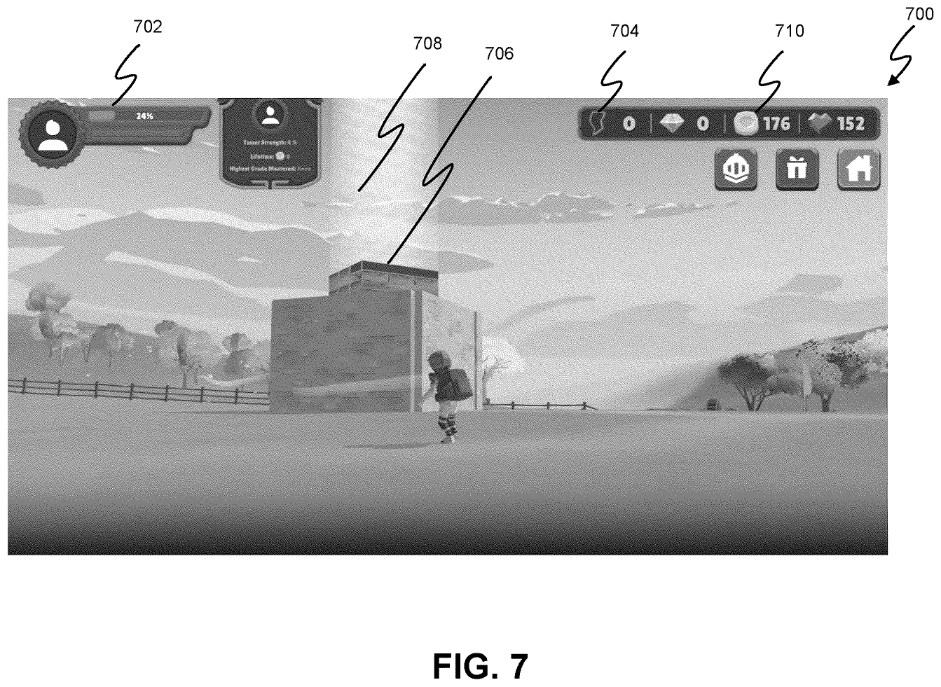

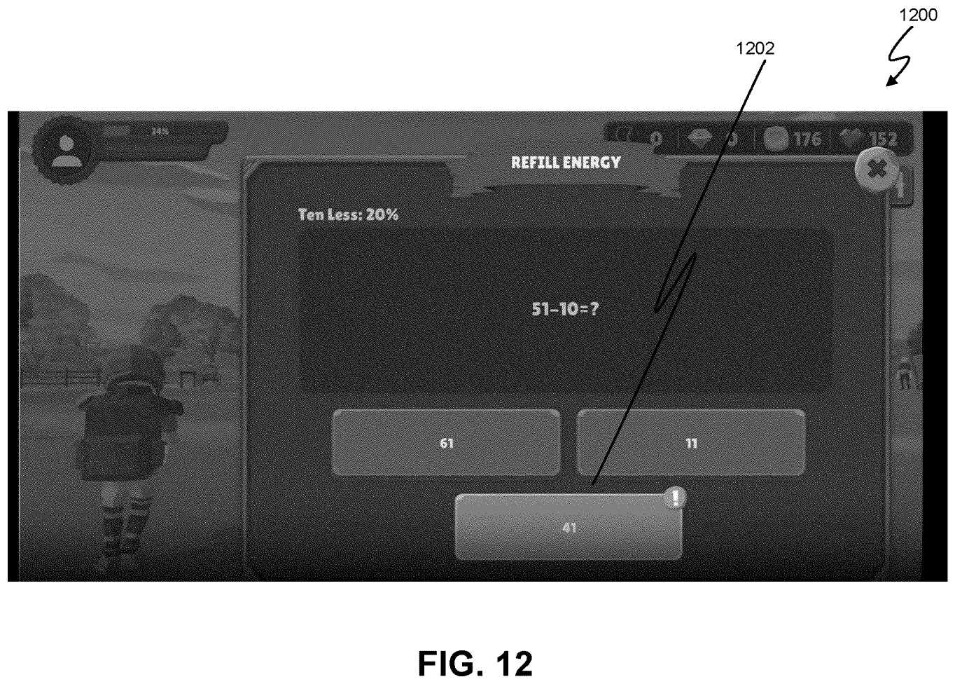

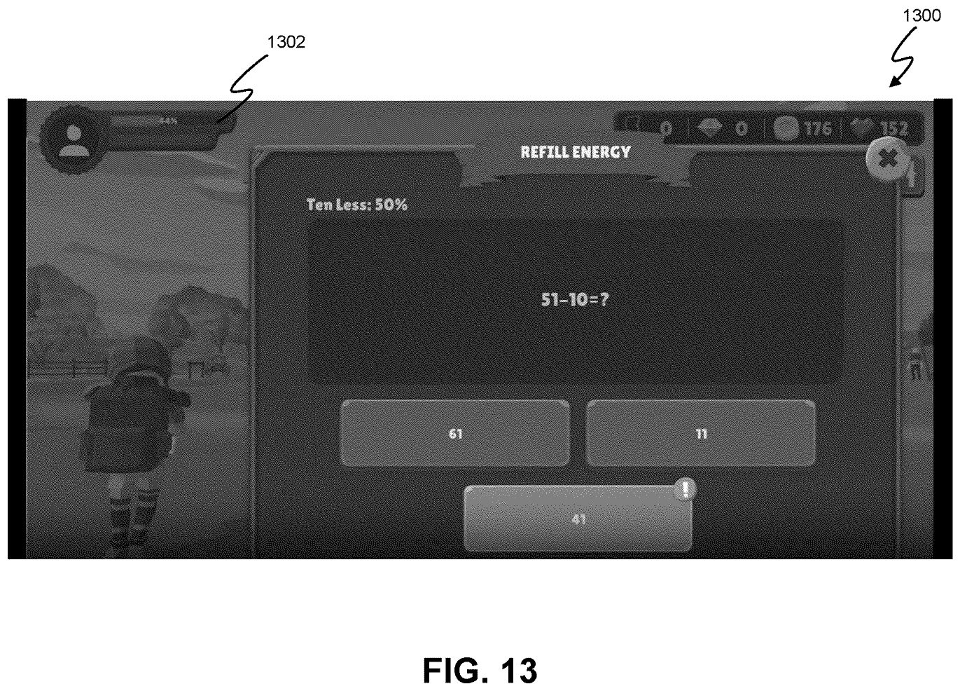

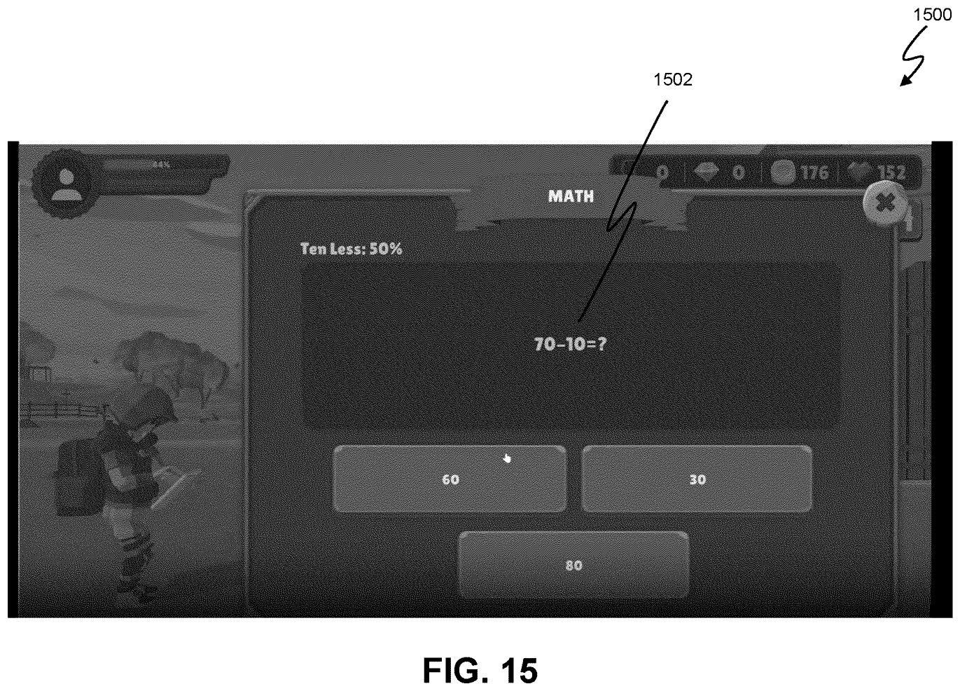

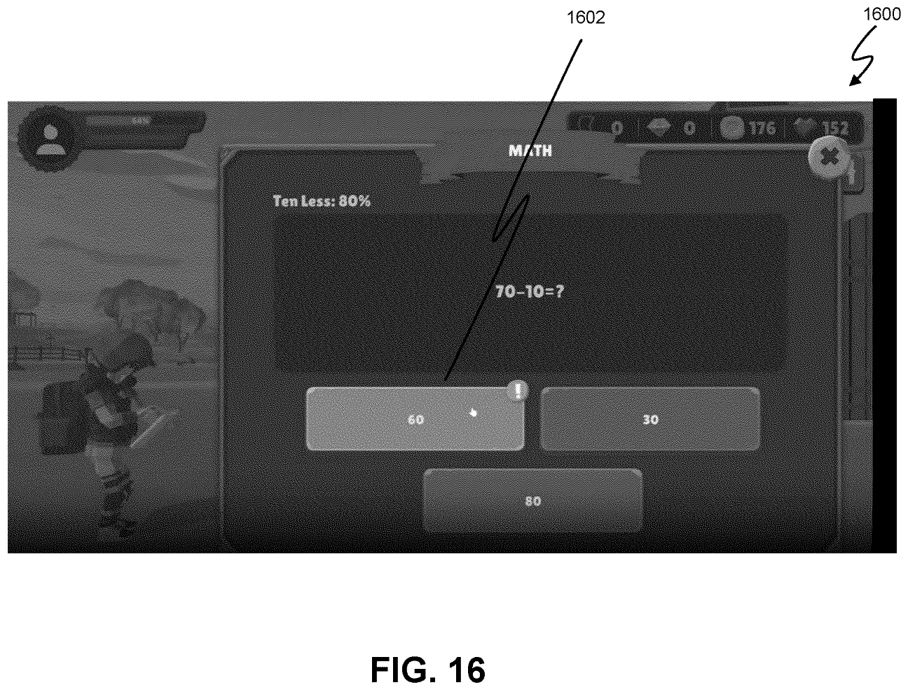

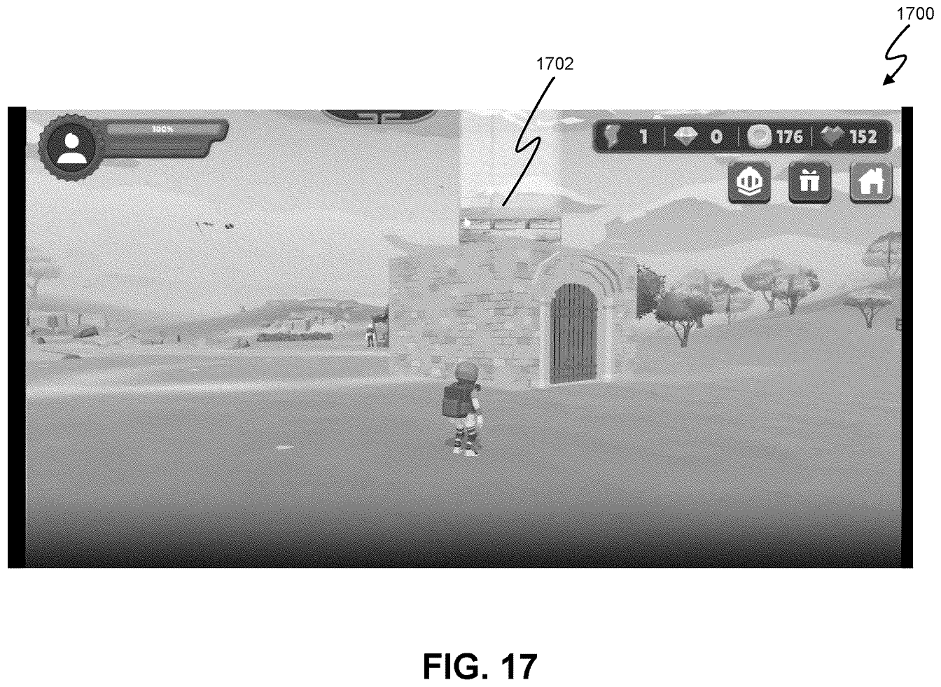

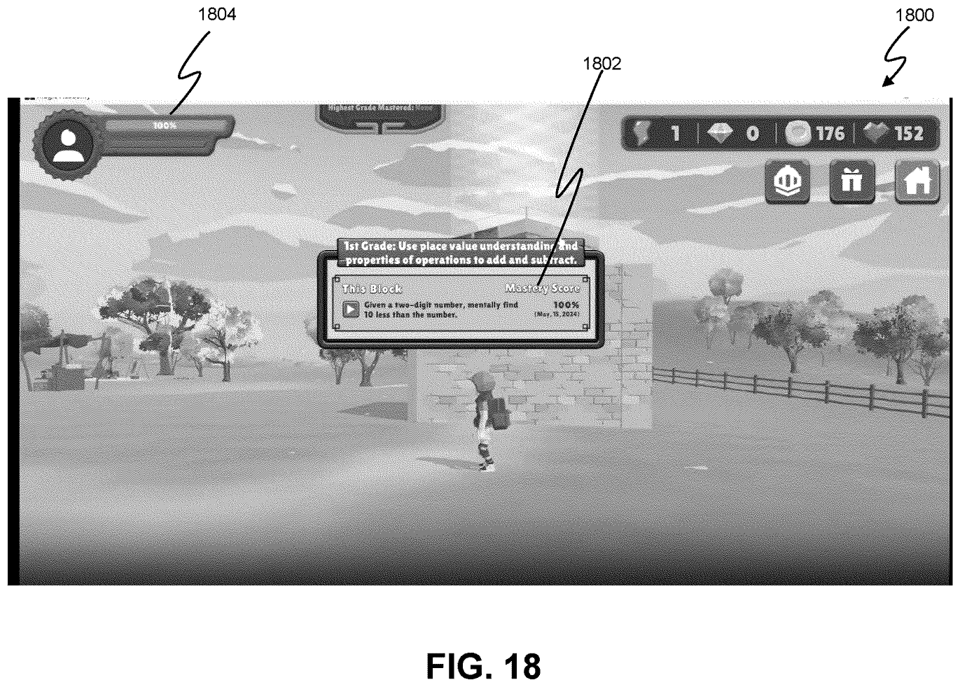

FIGS. 7-19 depict exemplary user interfaces generated in the gaming environment after the user successfully answers questions.

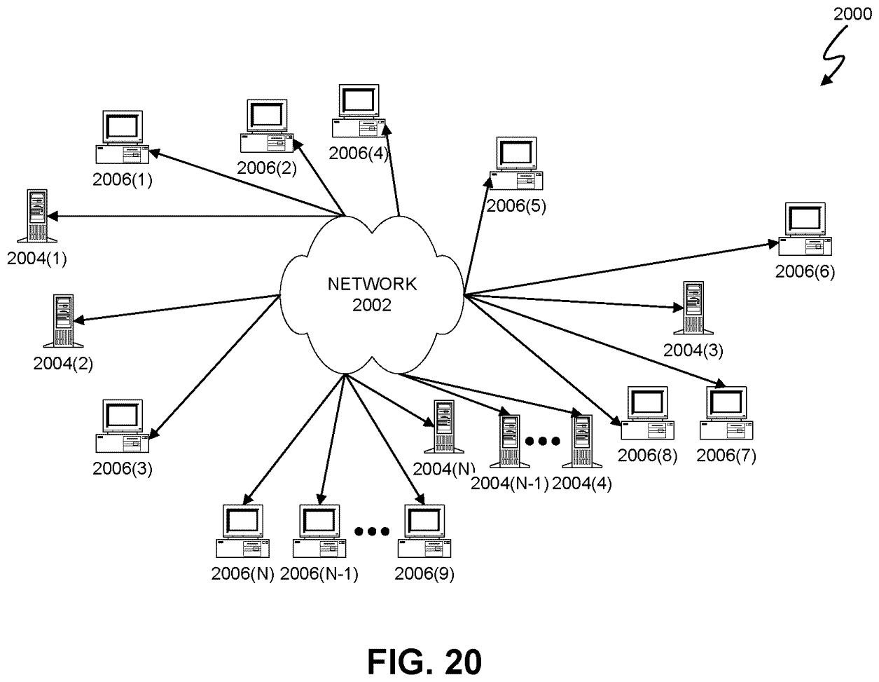

FIG. 20 depicts an exemplary network environment in which the system of FIG. 1 and the process of FIG. 2 may be practiced.

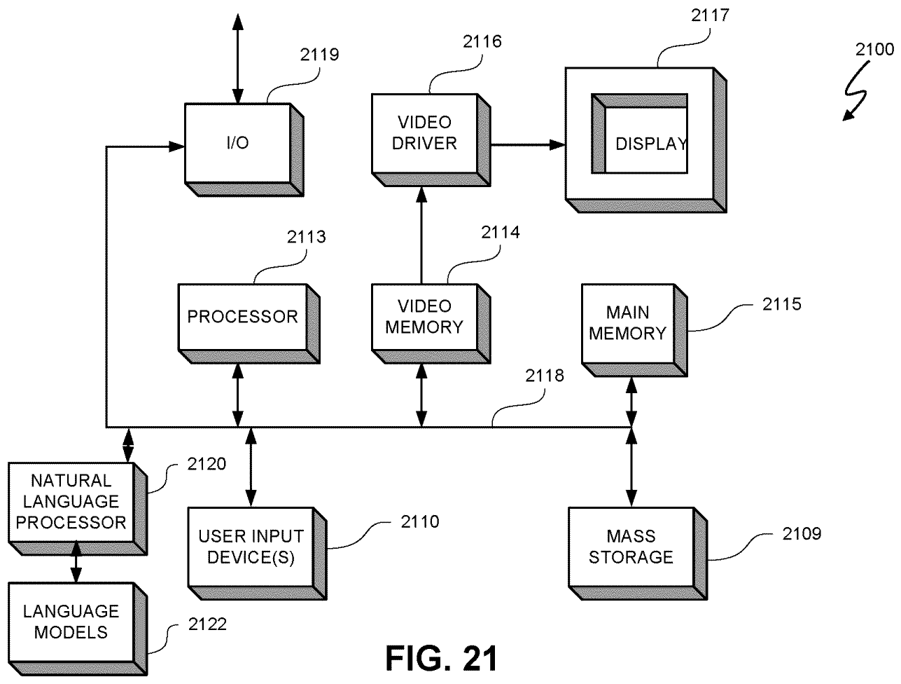

FIG. 21 depicts an exemplary computer system.

### DETAILED DESCRIPTION

An online gaming platform that integrates a base knowledge structure and unlocks new features in a gaming environment based on the user's knowledge of different educational concepts. The base knowledge structure is a default knowledge structure built on pre-defined knowledge or skills of the user. The base knowledge structure is made of a plurality of blocks and each block represents an individual educational concept related to a curriculum pursued by the user. Based on the knowledge gained by the user on the educational concepts, his mastery level of the concepts is updated which is reflected by the state of blocks in the knowledge structure. The height of the base knowledge structure increases as the user achieves educational milestones where each incremental growth in the knowledge structure corresponds to the knowledge gained by the user on one or more concepts. While the user is logged in to the online gaming platform and playing a game, the user is presented with different academic questions. The user attempts these academic questions and correct answers lead to an increase in the height of the base knowledge structure. Subsequently, a prompt is generated to guide the AI engine to unlock a plurality of new game features depending upon the new increased height of knowledge structure corresponding to each user in the gaming environment, while the user is playing the game.

Further, the knowledge structure serves as a visual example of how learning builds based on the previous knowledge of the user. If a user answers a question incorrectly, a weaker tower can be visualized indicating gaps in the prior knowledge of the user.

The gaming environment is designed to engage the user in learning by integrating academic achievements with gameplay progression. The knowledge structure within the gaming platform serves as a visual metaphor for the user's learning journey where each level within the tower indicates the mastery attained in a particular skill or concept.

The AI engine is used to unlock different features within the online gaming platform. By unlocking different features in response to educational milestones, the physical environment of the game is altered which provides a sense of accomplishment to the user. This visual educational progress helps in increasing the engagement of the user and provides a sense of motivation.

FIG. 1 depicts an exemplary online gaming environment 100. FIG. 2 depicts an exemplary online gaming environment process 200 utilized by the online gaming environment 100.

The online gaming environment 100 refers to a gaming environment where user 102 interacts and engages with an online gaming platform 104 through the internet. The online gaming environment 100 encompasses the knowledge structure that facilitates real-time communication and engagement with the user 102. The online gaming environment is a 3D environment that a user 102 can explore. The 3D gaming environment includes floating islands or parts of the world where the user 102 can perform different tasks.

Referring to FIGS. 1 and 2, in operation 202, include interaction of user 102 with the online gaming platform 104.

User 102 interacts with the online gaming platform 104 using different devices capable of supporting the Unity game engine, such as smartphones, tablets, and computers. User 102 logs into the online gaming platform 104 and is presented with various academic questions.

The user interface 106 within an online gaming platform 104 represents a 3D environment that a user 102 can explore. User 102 is presented with academic question 112 on the user interface 106. User 102 has to perform different tasks to explore new areas in the online gaming platform 104. In one of the embodiments, the tasks can be educational, fighting with the monster to progress in the game.

In operation 204, the base knowledge structure 110 is presented and then saved in the user profile 108, where the knowledge structure represents the knowledge gained by the user 102.

The user 102 initially logs onto the online gaming platform 104. The user 102 creates a user profile 108 which is presented on the user interface 106 within the online gaming platform 104. The user profile 108 in the online gaming platform 104 contains a range of information which includes personal details of the user 102. In at least one embodiment, the personal details of user 102 include age, grade, and topics selected by user 102 on the user interface 106. Moreover, for an existing user 102, the user profile 108 contains a range of information which includes in-depth records of the user's educational progress, achievements, and user's mastery history. Each user 102 has its unique profile and a base knowledge structure 110.

The personal details and the prerequisite knowledge of the user 102 are utilized to build the base knowledge structure 110. For example, if user 102 is studying at a 6th-grade level, the base knowledge structure 110 of user 102 will be created and saved within the user profile 108 based on his/her details and prerequisite knowledge. The user 102 will be presented with the academic content 112 and concepts related to the following grade level. The base knowledge structure is saved within the user profile 108. For an existing user 102, the base knowledge structure 110 updates to reflect the current mastery level of the concepts and is displayed on the user interface 106 in the form of a tower. The base knowledge structure 110 updates in real-time based on the interaction of user 102 with the academic content. It should be noted that the knowledge structure can be displayed in any form including pyramids, buildings, and other forms.

The base knowledge structure 110 is made of a plurality of blocks which are arranged hierarchically with a lower set of blocks serving as prerequisites for a higher set of blocks. The base knowledge structure 110 defines the skills user 102 has already mastered when user 102 logs in initially. For example, user 102 logs onto the online gaming platform 104 for the first time and is presented with a set of academic questions. Based upon the correctness of the answers and the prerequisite knowledge of the user, a base knowledge structure 110 is presented via the user interface 106. Each block of the base knowledge structure 110 represents the current mastery level of the user 102. The visual representation provides a clear and comprehensive overview of the current mastery level of user 102 based on the foundational educational concepts highlighting both their achievements and areas of improvement. The color coding within the blocks of the base knowledge structure is used to indicate the mastery level of the user 102. The mastery level of user 102 on individual educational concepts might be represented as individual block states such that the wooden block represents a learned state, the colored block represents that the user 102 is still in the learning process and the transparent block indicates an unknown state. The base knowledge structure 110, thus represents a visual knowledge of how learning builds on prior knowledge and identifies areas that require attention.

The base knowledge structure 110 represents the knowledge gained by the user 102. The solid wooden blocks within the base knowledge structure 110 represent the mastery of the educational concepts and the transparent blocks represent the knowledge gaps. Moreover, the transparent blocks represent that user 102 has not yet achieved mastery as the educational concept has not yet been attempted.

In operation 206, representing the increasing height of the knowledge structure as user 102 achieves educational milestones to increase the height of base knowledge structure 110.

The gaming system 114 is operatively coupled with the online gaming platform 104 and AI engine 122. The gaming system 114 tracks the tasks completed by user 102 and updates the information of user 102 in the user profile 108 in real time. In one of the embodiments, the gaming system is developed on unity cloud functionality, which makes real-time 3D experiences and game development more accessible.

The tower growth module 118 within the gaming system 114 calculates the growth of the knowledge structure based on the achievements of the user. Achievements are defined as the user's ability to complete the tasks and attain mastery of the concept. The tower growth module 116 takes into account the number and difficulty of academic questions answered, the completion of tasks, and mastery of each concept.

User 102 interacts with the game environment where user 102 has to complete different tasks to update the base knowledge structure 110. User 102 is presented with the academic content 112 on the user interface 106 which consists of a series of multiple choice questions that user 102 has to answer to update the base knowledge tower 110. In one of the embodiments, the questions can be fill-in-the-blanks, interactive problem-solving tasks, match the following, and so on.

The base knowledge structure 110 is clickable and clicking on the block represents an education concept that needs to be completed so the user 102 can move forward in the game. The base knowledge structure 110 can be a math block, where clicking on the block presents a math concept. For example, Alex, a middle school student starts playing the game and is excited to build his knowledge structure. Alex logs into the game and clicks on the base knowledge structure presented on his profile. As Alex clicks onto the block of the base knowledge structure 110, he is presented with a math question wherein the concept is related to “Use place value understanding and properties of operation to add and subtract” displayed on the online gaming platform 104. As Alex answers the questions such that answering them correctly, indicates mastery in that particular concept.

Each interaction with the block within the knowledge structure fills the block. User 102 completes the quizzes on addition and subtraction, the blocks corresponding to addition and subtraction concepts will transition from transparent to filled, demonstrating mastery. The educational concept which is still in progress can be visualized as a colored block making it easy for the user 102 to understand that he/she is still working on that concept. This visualization helps to monitor the progress of user 102 and identifies the concepts where user 102 is facing any problems.

As user 102 completes the educational tasks and achieves mastery, the gaming system tracks the progression of user 102. The tower growth module 116 then retrieves the base knowledge structure 110 from the user profile 108, calculates the growth of the knowledge structure, and updates the height of the knowledge structure which is now referred to as an updated knowledge structure 120 based on the achievements of the user.

The updated knowledge structure 120 represents the educational milestones a user 102 has achieved while playing the game. The updated knowledge structure 120 is further saved onto user interface 106. The height of the updated knowledge structure 120 increases every time the user 102 answers the questions correctly and completes a task. When user 102 achieves 100% percent mastery, the gaming system 114 recommends clicking on the next block to progress further in the game. In one of the embodiments, the updated knowledge structure 120 can be represented as a tower, a pyramid, or any suitable structure where blocks are aligned to show the interdependence of concepts.

Below is the function used to calculate the growth of the knowledge structure:

```
function calculateTowerGrowth(player achievements, taskCompletions,
masteryLevels):
  growthIncrement = 0
  for achievement in playerAchievements:
    growthIncrement += achievement.value
  for taskCompletion in taskCompletions:
    growthIncrement += taskCompletion.value
  for masteryLevel in masteryLevels:
    growthIncrement += masteryLevel.value
  return growthIncrement
```

In operation 208, generating a prompt to guide the AI engine 122 to unlock a plurality of new features in the gaming environment 100 depending upon the increased height of the knowledge structure corresponding to the user profile 108.

The gaming system 114 begins by receiving input from the online gaming platform 104 as the user 102 interacts with the base knowledge structure 110. This includes the interaction of user 102 with the academic content 112 presented to user 102 on an online learning platform 104, which allows the gaming system 114 to track the achievements of user 102 to update the base knowledge structure 110. The system involves the use of adaptive learning algorithms for incremental growth of the tower and providing access to new game features on the online gaming platform 104.

The tower growth module 116 also considers the user's academic achievement. The module analyzes the user's academic achievements to calculate the growth of the knowledge structure and adjusts its response accordingly by generating prompts for the AI engine 120.

The growth of the knowledge structure is limited by the user's academic progress and cannot exceed predefined thresholds without any academic achievements. For instance, if user 102 answers 3 questions related to a concept that is not enough to prove his mastery of that concept, the growth of the knowledge structure will not be impacted, thereby restricting prompt generation for AI engine 122 to unlock new features in the gaming environment 100.

A prompt generator 118 generates a prompt to guide the AI engine 122. The prompt generator 118 generates prompts based on the inputs received from the tower growth module 116. The prompt is a detailed set of instructions that guides the AI engine 122 in rendering the visualization of the updated knowledge structure 120. The prompt generator 118 is then used to create prompts to guide the AI engine 122 to unlock new features in the gaming environment 100. By integrating the context of base knowledge structure 110, user's achievements, task completions, and mastery level, the prompt generator 118 formulates relevant prompts. In at least one embodiment, user 102 can also adjust the academic difficulty and frequency of educational tasks.

These prompts are then transferred to the AI engine 122 which processes them to unlock new features in the gaming environment. The unlocking of new features in response to educational milestones provides user 102 with a more concrete and satisfying sense of accomplishment.

In operation 208, the prompt to the AI engine 122 is transferred to unlock the new game features in the gaming environment 100 while user 102 is playing the game.

These prompts are then transferred to the AI engine 122 which processes them to unlock new features 124 in the gaming world. Typically, an AI engine 122 gathers the user's mastery level, user's academic achievements, and information on completion of tasks. The mastery level provides quantifiable measures of the understanding and mastery of various educational concepts of the user 102. Further, the mastery level is mapped onto the updated knowledge structure 120. Once the mastery level is mapped onto the updated knowledge structure 120, the AI model is employed.

The updated knowledge structure 120 and the advancement of the height of the structure unlock new features 122 of the gaming environment. As the new features are unlocked, the user 102 can access different areas in the gaming environment. The user 102 can enter the knowledge structure and climb it. As the user 102 climbs the updated knowledge structure 120 the user 102 can have access to more of the 3D world in the gaming environment 100. The 3D game world offers a more simulated sense of depth and space allowing for exploration of different parts of the gaming world and making the game more fun and challenging. As user 102 unlocks different parts of the 3D world, the 3D world enhances the sense of realism of different objects, motions, and interactions.

The user 102 can also glide from the updated knowledge structure 120. The user 102 can also unlock chest treasures and receive different coins for completing the blocks. The coins can be collected and used for different purposes. The coins can be used to buy-in game items, increasing the life-span of the character and more.

The increased height of the knowledge structure can also unlock a unique customisation of the character in the game world. The user 102 can access different stylish clothings for his/her character in the game such as hat, mask, boots, and so on. User 102 can access the shield where the shield can be used to block attacks by monsters. The shield can be used to protect the character in the gaming environment 100. The user 102 can also engage with fellow gamers where the user 102 can visualize the knowledge structure of the fellow game members thus introducing a sense of competition and motivation to build his/her knowledge structure.

The strength of the user 102 increases as the user 102 completes the tasks. The strength of user 102 relates to the updated knowledge structure 120. As the user 102 gains more strength, the energy level of the user 102 increases. The increased energy helps the user 102 to complete various tasks at a higher pace. The increased energy levels help the user 102 to fight the monsters, climb the updated knowledge structure 120, and so on.

The AI engine 122 uses adaptive learning algorithms, data mining, machine learning, and statistical analysis to adjust the difficulty of the academic questions which aligns with the player's learning curve. The data mining techniques help in extracting useful patterns and insights from the mastery level. After processing the mastery level, the user's academic achievements, and task completion to generate the updated knowledge structure 120, the prompt for the AI engine 122 is generated.

The AI engine 122 is configured to process educational data points and translate them into in-game progress. The AI engine 122 prompts to unlock new features within the online gaming platform 104. The adaptive placement system uses AI to generate content based on the user's performance. The adaptive content delivery system within the AI engine 122 serves different challenges to user 102 as user 102 progresses in the game. In one of the embodiments, the difficulty of academic questions and the frequency of educational tasks can be adjusted. The AI engine 122 is trained on a dataset of player interactions, including correct and incorrect answers to academic questions, to refine the adaptive learning model. It is designed to produce consistent outputs that reflect the player's educational progress.

These new features provide a more concrete and satisfying sense of accomplishment to the user 102. The real-time construction of the knowledge tower and the addition of new features keep the user 102 informed about their progress, motivating them to continue engaging with the online gaming platform 104. In at least one embodiment, the visual representation of the knowledge structure may use animations to highlight changes in the updated knowledge structure 120, such as when a block transitions from transparent to solid wooden blocks after the educational concept is mastered. These visual elements help maintain the user 102 interest and make the knowledge structure an attractive and motivating tool.

Below is the code of the online gaming platform:

```
  // Pseudo-code for Customizable Tower as a Representation of Knowledge Progress
  // Function to initialize the player's tower
  function initializeTower(playerID) {
    // Create a new tower object for the player with a base height
    Tower tower = new Tower(baseHeight = 1)
    // Save the tower object in the player's profile
    saveTowerToProfile(playerID, tower)
  }
  // Function to update the tower's height based on the player's achievements
  function updateTowerHeight(playerID, achievements) {
    // Retrieve the player's tower object from their profile
    Tower tower = getTowerFromProfile(playerID)
    // Calculate the new height based on the number of achievements
    int newHeight = calculateHeightFromAchievements(achievements)
    // Update the tower's height
    tower.setHeight(newHeight)
    // Save the updated tower object in the player's profile
    saveTowerToProfile(playerID, tower)
    // Unlock new areas of the game world based on the tower's height
    unlockGameAreas(playerID, tower.height)
  }
  // Function to calculate the tower's height from achievements
  function calculateHeightFromAchievements(achievements) {
    // Initialize a height variable
    int height = 0
    // Loop through each achievement
    foreach (achievement in achievements) {
      // Increase the height based on the achievement's value
      height += achievement.value
    }
    // Return the calculated height
    return height
  }
  // Function to unlock new game areas based on the tower's height
  function unlockGameAreas(playerID, towerHeight) {
    // Determine which areas to unlock based on the tower's height
    GameArea[ ] areasToUnlock = getAreasToUnlock(towerHeight)
    // Unlock each area for the player
    foreach (area in areasToUnlock) {
      unlockAreaForPlayer(playerID, area)
    }
  }
  // Function to save the tower object to the player's profile
  function saveTowerToProfile(playerID, Tower tower) {
    // Implementation specific to the game's data storage system
    // Reference to the codebase: Unity Cloud Save functionality
  }
  // Function to get the tower object from the player's profile
  function getTowerFromProfile(playerID) {
    // Implementation specific to the game's data storage system
    // Reference to the codebase: Unity Cloud Save functionality
  }
  // Function to get the list of areas to unlock based on the tower's height
  function getAreasToUnlock(towerHeight) {
    // Implementation specific to the game's world design
    // Reference to the codebase: Game world design and area access control
  }
  // Function to unlock a game area for the player
  function unlockAreaForPlayer(playerID, GameArea area) {
    // Implementation specific to the game's multiplayer and access control systems
    // Reference to the codebase: Photon Fusion for multiplayer
  }
  digraph G {
    rankdir=LR;
    nodesep=1.0;
    node [shape=box];
    initialize −> saveTowerToProfile [label=“ Initialize tower ”];
    updateTowerHeight −> getTowerFromProfile [label=“ Retrieve tower ”];
    updateTowerHeight −> calculateHeightFromAchievements [label=“ Calculate new
height ”];
    updateTowerHeight −> saveTowerToProfile [label=“ Save updated tower ”];
    updateTowerHeight −> unlockGameAreas [label=“ Unlock new areas ”];
    calculateHeightFromAchievements −> returnHeight [label=“ Return calculated height ”];
    unlockGameAreas −> getAreasToUnlock [label=“ Get areas to unlock ”];
    unlockGameAreas −> unlockAreaForPlayer [label=“ Unlock area for player ”];
  }
```

FIG. 3 depicts a relationship generation process 300 between an updated knowledge structure 120 and the online gaming environment 100, which is an embodiment of the online gaming environment process 200 of FIG. 2. The updated knowledge structure 120 is implemented in the game environment 302. The updated knowledge structure 120 presents an interactive visualization to represent the progress of user 102. The game environment 302 is designed in such a way to engage the user 102 in learning by integrating academic achievements with the gameplay progression. The game environment presents academic content 112 to the user 102. As user 102 interacts with the online gaming platform 104 user 102 has to answer various types of questions such that answering them right will update the height of the base knowledge structure 110. Notably, each block within the knowledge structure corresponds to a specific educational concept, the blocks arranged together vertically represent the current set of mastery levels of the user 102. The visual representation of achievement 304 provides a clear overview of the current mastery level of the user 102 thus highlighting their achievements. The updated knowledge structure 120 serves as a visual and interactive metaphor for the player's learning journey, where each level of the structure corresponds to the mastery of new skills or subject matter.

The real-time construction of the knowledge structure based on the user's learning provides a sense of motivation and engagement 306 for the user 102. As the user 102 masters new concepts, the base knowledge structure 1 10 grows in height and is saved as updated knowledge structure 120. The transition of the blocks from transparent to wooden provides an appealing character to the knowledge structure. For instance, Alex logs onto the game environment 100 and is presented with different academic content 112. Alex answers the questions and answers them correctly indicating mastery and updates the knowledge structure. Alex is presented with different rewards, coins, badges, and an increase in energy level. These rewards are displayed in the game environment 302 providing a sense of accomplishment to the user 102. The gaming rewards and the visualization, thus motivate students to perform more tasks and master educational concepts.

The game progression is achieved as the user 102 achieves mastery and answers the questions correctly which is displayed onto the game environment 302. The game environment 302 states the goals for the user to define their progress and reinforce it by making the user 102 aware of how close or far they are from the end goal. As user 102 completes different educational tasks the game progresses. The game environment 302 is designed to engage the user 102 in learning by integrating academic achievements with gameplay progression.

In at least one of the embodiments, the knowledge structure can be adapted for different platforms. The knowledge structure can be incorporated into online teaching programs where the progress of students can be visualized in real time. The incorporation of knowledge structure makes it easy for the teachers to identify the foundational concepts of the students.

The knowledge structure can be adapted for classroom learning 316. The knowledge structure within the classroom learning 316 can be used for collective class achievements or individual student progress. The height of the updated knowledge structure 120 indicates the mastery of the user's concepts.

The knowledge structure can be adapted for professional training 318 programs. The knowledge structure can be used to understand the progress of professionals in corporate training. These virtual structures can be used to motivate professionals.

FIG. 4 depicts a game world update process 400, which is an embodiment of the online gaming environment process 200 of FIG. 2. The flowchart depicts the steps involved in the game world update 412 using the tower growth module 116. Initially, the process starts with the collection of user achievements 402, task completions 406, and mastery levels 408. The user achievements 402 are defined as a collection of the user's completed educational achievements. The task completions 406 are a record of the educational tasks completed by the user 102 and the mastery level 408 indicates the level of mastery the user 102 has achieved in various subject areas. A database is used for storing user details for individual users, the state of mastery of educational concepts of each user, and the interaction of the user 102 with the knowledge structure in a database.

This data is then compiled and distributed to the tower growth module 116. The tower growth module 116 is responsible for the incremental growth of the knowledge structure 410. As the knowledge structure updates new features are incorporated based on the inputs received from the online gaming platform 102. Based on the growth of knowledge structure the game world updates 412.

For instance, Alex logs into the game and is presented with a math question. Upon answering correctly, the game records the achievements. The tower growth module calculates the new height of Alex's knowledge structure. The game world updates and Alex's knowledge structure typically grows, thereby unlocking new features in the gaming world.

FIG. 5 depicts the sequence diagram 500 for unlocking new features 122 within the online gaming platform 104. The user 102 logs into the online gaming platform 104 through a computing device connected to the internet and having access to a browser 502. The game can be played without the need for additional software, where the user 102 interacts with the game server 504 and answers the questions displayed on the user interface 106. The game server records the achievements and sends the prompt to the tower growth module 116 to calculate the growth of the knowledge structure. The updated knowledge structure 120 is shared with the game server 504. The game server then unlocks different features in the gaming world that engage and encourage the user 102.

FIG. 6 depicts a data structure 600 for the knowledge structure 602 which represents the knowledge progress of user 102. The data structure 600 includes a plurality of components that make up the knowledge structure 602 and their coordinate 606. The knowledge structure 602 is made of an array of blocks where each block 604 indicates the educational concept of the user 102. The height of the blocks is defined by integers where the value of integers indicates the height of the knowledge structure 602. The height of the block also increases upon the achievement of the user. The achievements are defined by the string wherein the string represents a word input of users' achievements. The current height attribute represents the user's current knowledge progress. The access area attribute provides a list of new areas that will be unlocked as the knowledge structure 602 grows.

The coordinate 606 attribute provides the location of the knowledge structure. The coordinates x, y, z are defined by float values. The float values are decimal values that define the coordinates of the structure and provide the direction where the knowledge structure is located.

FIGS. 7-19 depicts exemplary user interfaces 700, 800, and 900 generated in the gaming environment 100 after the user successfully answers questions. Referring to FIG. 7, an exemplary user interface 700 shows the user's 102 knowledge structure built on the user's 102 prerequisite educational concepts. As shown, the knowledge structure of user 102 is made of different blocks. The knowledge structure of user 102 depicting the red-colored block 706 indicates that user 102 is still working on that concept or has worked on the educational concept in the past. The knowledge structure of user 102 also consists of transparent block 708 which indicates that user 102 still has to visit that block to answer the questions presented to user 102 on that particular block. Furthermore, the user interface 106 also displays the energy tab 702, mastery tab 704, and reward tab. The academic progress can be used to increase the energy levels in the energy tab 702 and mastery levels in the mastery tab 704.

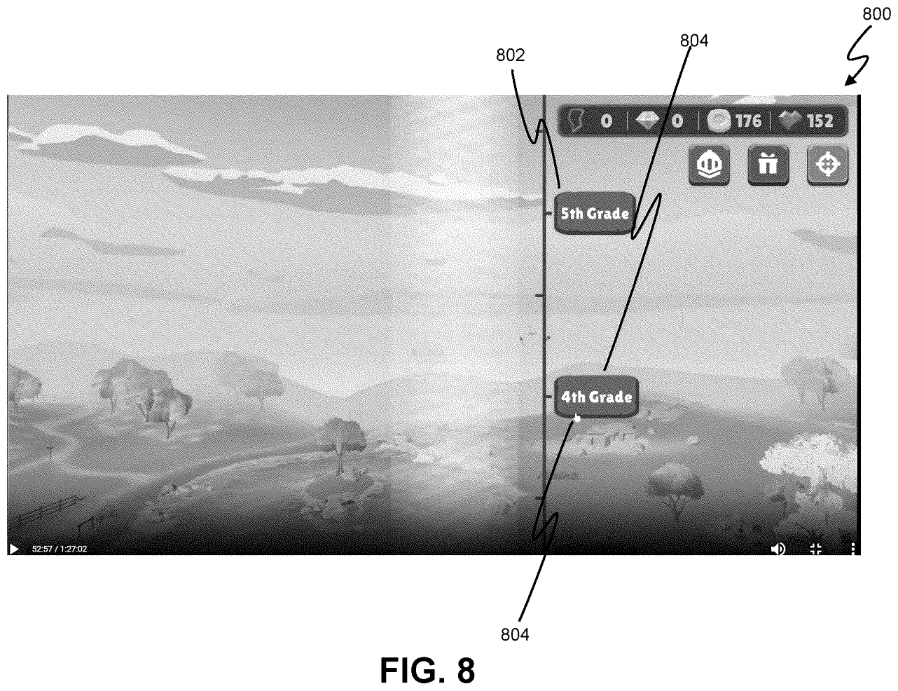

Referring to FIG. 8, depicts an exemplary user interface 800, showing a knowledge structure that consists of different blocks from 4th grade including concepts that are prerequisites for 5th grade. The knowledge structure shows different fundamental concepts related to 4th grade and 5th grade. The transparent blocks represent that the user 102 still has to visit these blocks for the tower to grow. The pop-up 804 allows the user 102 to click on the block and open the question related to grade 4. The interface is then displayed with a concept that is relevant to grade 4.

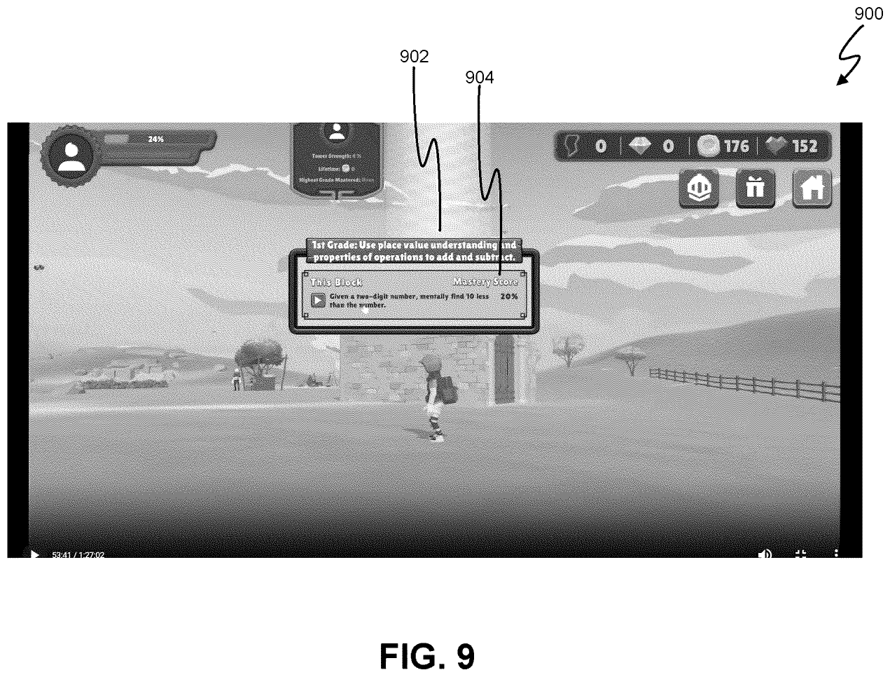

FIG. 9 depicts an exemplary user interface 900, showing a block from 1st grade. The user interface 900 shows a fundamental 1st-grade educational concept like “use place value understanding and properties of operations to subtract. By interacting with the user interface and answering the academic questions, user 102 can see a mastery score 904. The mastery score 904 indicates the understanding of the user 102 for that particular concept. This visualization aids in understanding the user's knowledge of the 1st-grade educational concept.

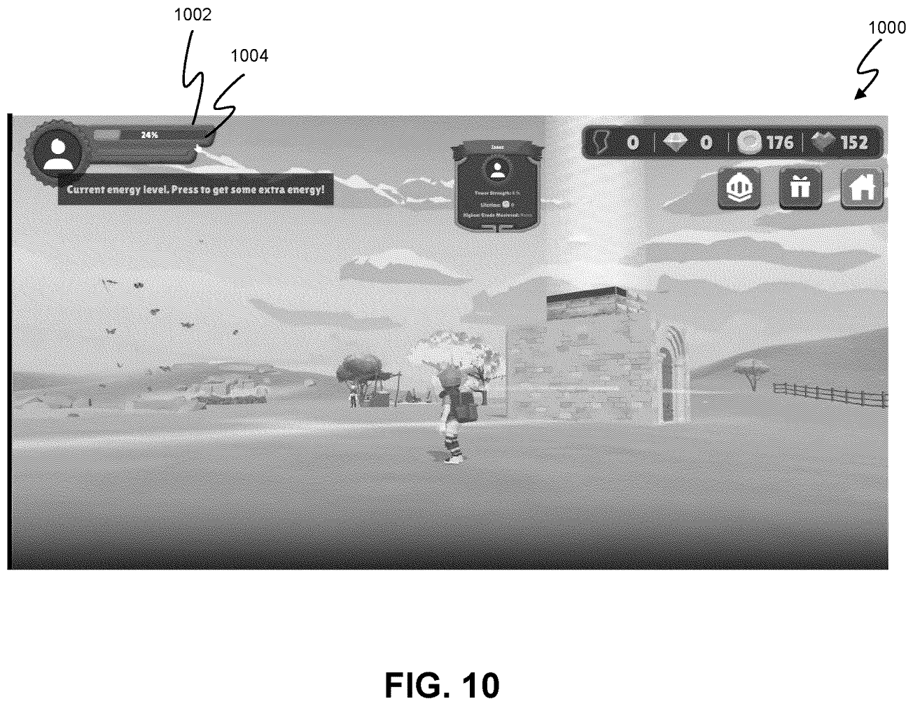

Referring to FIG. 10, depicts an exemplary user interface 1000, showing the current energy level 1002 within the energy tab 702. The energy level of the user 102 is required to perform different tasks within the game. The tasks include climbing the knowledge structure and gliding from the structure to have access to the 3D world. The current energy level of the user 102 is 24 percent 1002. The academic progress can also be used to fill the energy tab thereby increasing the energy of the user 102 to perform different tasks within the gaming platform. The pop-up 1004 is presented to click on the energy tab 702 to display an academic question to the user 102.

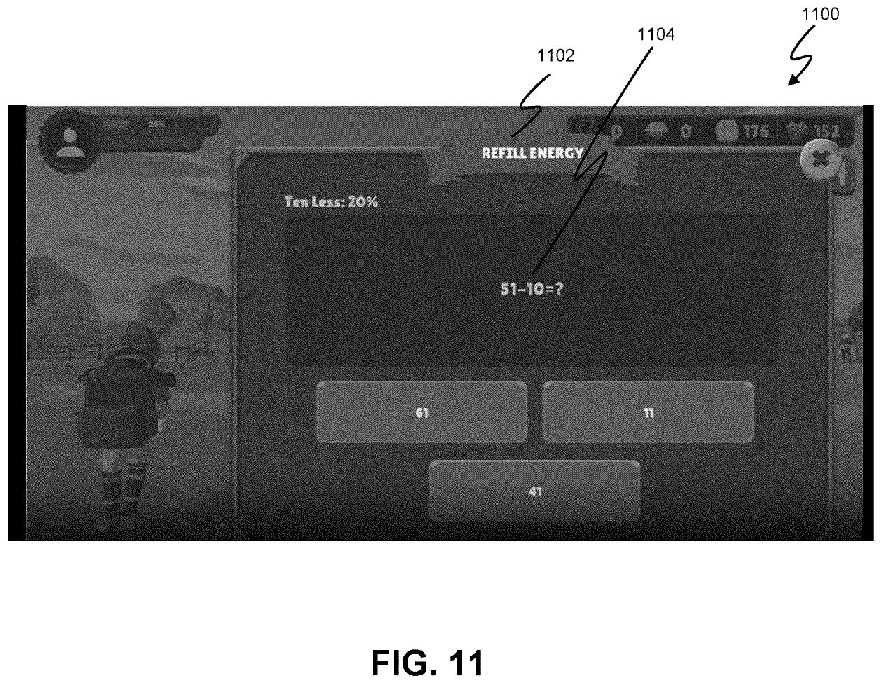

FIGS. 11,12 and 13 depict an exemplary user interfaces 1100, 1200, 1300 showing the use of academic progress to increase the energy of the user 102. The academic question 1104 is presented to user 102. As user 102 responds to the question the energy refill 1102 is observed. The question includes a multiple-choice question. The user 102 responds 1202 to a multiple choice question which is displayed onto the user interface 106. As user 102 responds to the questions such that answering them correctly, will increase the energy level from 24% 1002 to 44% 1302. The user 102 is presented with several other questions, so every time the user 102 answers the questions correctly the energy refills. The energy can be used to complete different tasks presented in the gaming world.

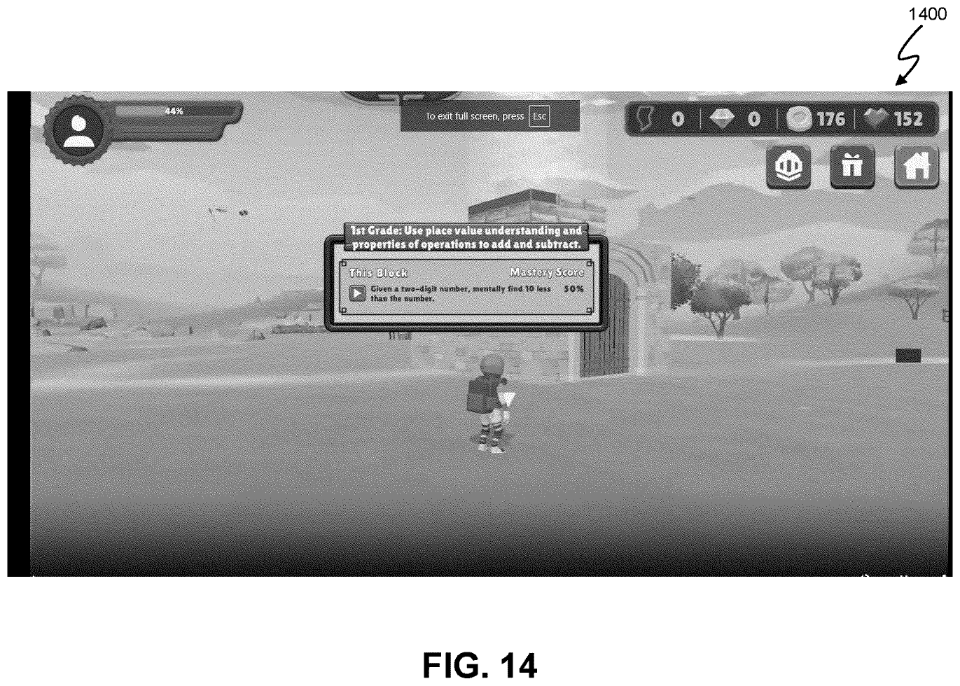

FIGS. 14, 15, 16, 17,18, depict exemplary user interfaces 1400,1500, 1600, 1700, and 1800 showing the building of knowledge structure to unlock new features in the gaming world. The knowledge structure represents a math tower. User 102 is presented with a math question 1502 on the following concept: “place value understanding and properties of operations to add or subtract”. The knowledge structure depicts solid wooden blocks and red-colored blocks. The wooden blocks represent the learned state of the user 102 and the red block depicts the learning state of the user 102. By clicking on the red block 706, user 102 is presented with a math question 1502. As user 102 responds to the questions correctly, the mastery level of user 102 is attained within that block representing knowledge of that concept. When user 102 completes a series of quizzes on “addition and subtractions”, the blocks corresponding to addition and subtraction concepts would transition from red 706 to wooden 1702, demonstrating mastery. Upon answering all the concepts within that block, the energy refills 1804 to 100 percent, and the mastery score 1802 reaches to 100% indicating complete mastery of the concept.

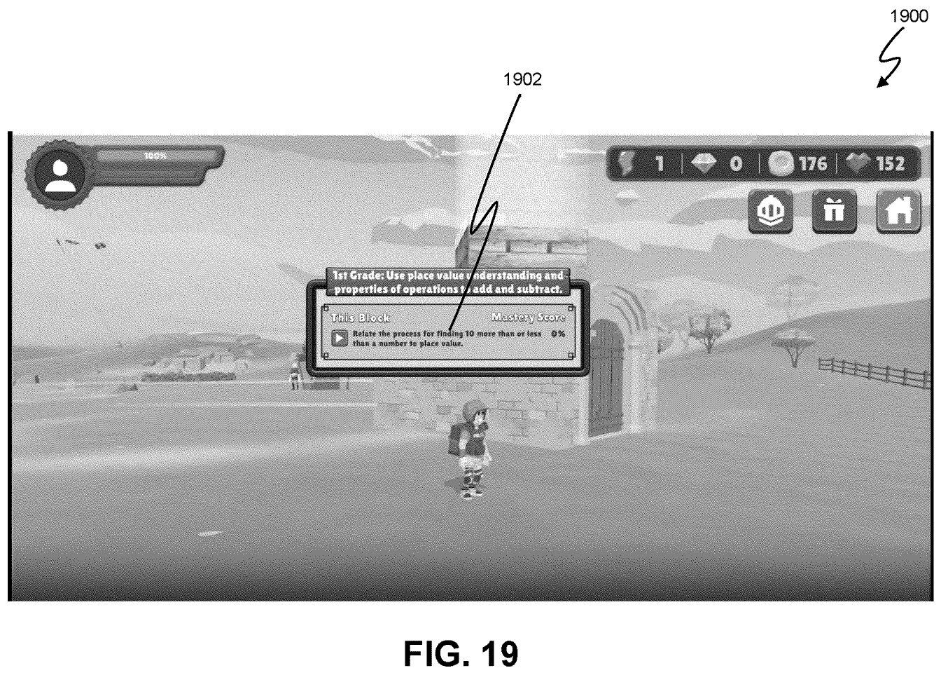

FIG. 19, depicts an exemplary user interface 1900, representing the next level for the growth of the knowledge structure. As user 102 completes the previous block, the knowledge structure recommends that user 102 start the next level. The next level is represented by transparent blocks which involve answering to different concepts 1902. The mastery score of the new block is also 0% indicating that user 102 is still yet to answer the question.

As user 102 completes the blocks and answers the questions correctly, the knowledge structure builds. As the knowledge structure builds, new gaming features are unlocked within the game environment 100. The user 102 can enter, climb, and scale the knowledge structure. The user 102 can then open different treasure chests and gain energy to perform different tasks within the gaming world. The stamina cost of the user 102 also increases to fight different creatures. The knowledge structure presents a visualization of educational progress within the gaming environment and enhances the motivation and engagement among the users.

FIG. 20 is a block diagram illustrating a network environment in which a real-time tutor generation system 100 and process 200 using Artificial Intelligence for adaptive learning may be practiced. Network 2002 (e.g. a private wide area network (WAN) or the Internet) includes several networked server computer systems 2004(1)-(N) that are accessible by client computer systems 1606(1)-(N), where N is the number of server computer systems connected to the network. Communication between client computer systems 2006(1)-(N) and server computer systems 2004(1)-(N) typically occurs over a network, such as a public switched telephone network over asynchronous digital subscriber line (ADSL) telephone lines or high-bandwidth trunks, for example, communications channels providing T1 or OC3 service. Client computer systems 2006(1)-(N) typically access server computer systems 2004(1)-(N) through a service provider, such as an internet service provider (“ISP”) by executing application-specific software, commonly referred to as a browser, on one of client computer systems 2006(1)-(N).

Client computer systems 2006(1)-(N) and server computer systems 2004(1)-(N) are specialized computers programmed to improve conventional computer systems to implement and utilize the real-time tutor generation system 100 and process 200 using Artificial Intelligence for adaptive learning. The type of computer system that can be specially programmed to implement and utilize the real-time tutor generation system 100 and process 200 using Artificial Intelligence for adaptive learning includes a mainframe, a mini-computer, a personal computer system including notebook computers, a wireless, mobile computing device (including personal digital assistants, smartphones, and tablet computers). These computer systems are typically designed to provide computing power to one or more users locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the real-time tutor generation system 100 and process 200 using Artificial Intelligence for adaptive learning can be implemented using code stored in a tangible, non-transient computer-readable medium and executed by one or more processors. In at least one embodiment, the real-time tutor generation system 100 and process 200 using Artificial Intelligence for adaptive learning can be implemented completely in hardware using, for example, logic circuits and other circuits including field programmable gate arrays.

Embodiments of the real-time tutor generation system 100 and process 200 using Artificial Intelligence for adaptive learning can be implemented on a computer system such as a special-purpose, special-programmed computer 2100 illustrated in FIG. 20. Input user device(s) 2110, such as a keyboard and/or mouse, are coupled to a bi-directional system bus 2118. The input user device(s) 2110 are for introducing user input to the computer system and communicating that user input to processor 2113. The computer system of FIG. 21 generally also includes a non-transitory video memory Y14, non-transitory main memory 1715, and non-transitory mass storage 2109, all coupled to bi-directional system bus 2118 along with input user device(s) 2110 and processor 2113. The mass storage 2109 may include fixed and removable media, such as a hard drive, one or more CDs or DVDs, solid state memory including flash memory, and other available mass storage technology. Bus 2118 may contain, for example, 32 of 64 address lines for addressing video memory 2114 or main memory 2115. The system bus 2118 also includes, for example, an n-bit data bus for transferring DATA between and among the components, such as CPU 2109, main memory 2115, video memory 2114, and mass storage 2109, where “n” is, for example, 32 or 64. Alternatively, multiplex data/address lines may be used instead of separate data and address lines.

I/O device(s) 2119 may provide connections to peripheral devices, such as a printer, and may also provide a direct connection to a remote server computer systems via a telephone link or to the Internet via an ISP. I/O device(s) 2119 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection, or the like. Examples of I/O devices include modems, sound and video devices, and specialized communication devices such as the aforementioned network interface.

Computer programs and data are generally stored as code in a non-transient computer-readable medium such as flash memory, optical memory, magnetic memory, compact disks, digital versatile disks, and any other type of memory. The computer program is loaded from a memory, such as mass storage 2109, into main memory 2115 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 2113, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 2115 is comprised of dynamic random access memory (DRAM). Video memory 2114 is a dual-ported video random access memory. One port of the video memory 2114 is coupled to the video amplifier 2116. The video amplifier 2116 is used to drive the display 2117. Video amplifier 2116 is well known in the art and may be implemented by any suitable means. This circuitry converts pixel DATA stored in video memory 2114 to a raster signal suitable for use by display 2117. Display 2117 is a type of monitor suitable for displaying graphic images.

The computer system described above is for purposes of example only. The real-time tutor generation system 100 and process 200 using Artificial Intelligence for adaptive learning may be implemented in any type of computer system programming or processing environment. It is contemplated that the real-time tutor generation system 100 and process 200 using Artificial Intelligence for adaptive learning might be run on a stand-alone computer system, such as the one described above. The real-time tutor generation system 100 and process 200 using Artificial Intelligence for adaptive learning might also be run from a server computer systems system that can be accessed by a plurality of client computer systems interconnected over an intranet network. Finally, the real-time tutor generation system 100 and process 200 using Artificial Intelligence for adaptive learning may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for guiding an Artificial Intelligence (AI) engine to unlock new features within an online gaming platform based on user's academic progress comprising:
executing code using one or more processors of a computer system to cause the computer system to perform operations comprising:
providing a user interface allowing the user to interact with the online gaming platform;
creating a base knowledge structure and saving the base knowledge structure in a user profile, wherein the knowledge structure represents knowledge gained by the user on various skills;
increasing the height of the knowledge structure as the user achieves educational milestones, wherein each incremental growth of the knowledge structure corresponds to a specific level of knowledge gained by the user;
generating a prompt to guide the AI engine to unlock a plurality of new features in a gaming environment depending upon the increased height of the knowledge structure corresponding to the user profile, wherein the plurality of new game features are accessible when the knowledge structure reaches a predefined height; and
transferring the prompt to the AI engine to unlock the new game features in the gaming environment while the user is playing the game.

2. The method of claim 1 unlocking the plurality of new features further comprises creating challenges within the online gaming platform while the user plays the game, and successful completion of the challenges results in an increase in the height of the knowledge structure.

3. The method of claim 1 for guiding an Artificial Intelligence (AI) engine to unlock new features within an online gaming platform further comprises providing a real-time feedback to the user corresponding to their educational progress through visual elements related to the growth of the knowledge structure.

4. The method of claim 1 wherein the knowledge structure is made up of plurality of blocks such that each block represents an individual educational concept and a mastery level of the user on the corresponding concept.

5. The method of claim 1, wherein the mastery level of the user on individual educational concepts is represented as an individual block state, wherein the learned state is represented as a solid wooden block, learning state is represented as a colored block, and unknown state is represented as a transparent block.

6. The method of claim 1 further comprises utilizing an algorithm to calculate incremental increases in the height of the knowledge structure, wherein the algorithm takes into account the number of academic questions answered by the user and the difficulty level of each question.

7. The method of claim 1, wherein the knowledge structure can be represented as a tower, a pyramid, or any suitable structure where blocks are aligned to show the inter-dependency of concepts.

8. The method of claim 1 further comprising:
storing user details for individual users, state of mastery on educational concepts of each user, and interaction of the user with the knowledge structure into a database.

9. A system for guiding an Artificial Intelligence (AI) engine to unlock new features within an online gaming platform based on user's academic progress comprising:
one or more processors;
memory, operatively coupled to the one or more processors that when executed cause the one or more processors to perform operations comprising:
executing codes using one or more processors of a computer system to cause the computer system to perform operations comprising:
providing a user interface allowing the user to interact with the online gaming platform;
creating a base knowledge structure and saving the based knowledge structure in a user profile, wherein the knowledge structure represents knowledge gained by the user on various skills;
increasing the height of the knowledge structure as the user achieves educational milestones, wherein each incremental growth of the knowledge structure corresponds to a specific level of knowledge gained by the user;
generating a prompt to guide the AI engine to unlock a plurality of new features in a gaming environment depending upon the height of the knowledge structure corresponding to the user profile, wherein the plurality of new game features are accessible when the knowledge structure reaches a predefined height; and
transferring the prompt to the AI engine to unlock the new game features in the gaming environment while the user is playing the game and updating the height of the knowledge structure to display the educational milestones attained by the user.

10. The system of claim 9, wherein unlocking new features in the online gaming environment includes providing access to one or more new game areas, engaging with fellow gamers, and additional features that enhances the gaming capabilities of the user.

11. The system of claim 9, wherein unlocking the plurality of new features further comprises creating challenges within the online gaming platform while the user plays the game, and successful completion of the challenges results in an increase in the height of the knowledge structure.

12. The system of claim 9, wherein the knowledge structure is made up of plurality of blocks each representing an individual educational concept and a mastery level of the user on each educational concept is represented by a block in the knowledge structure.

13. The system of claim 9, wherein the mastery level of the user on individual educational concepts is represented as an individual block state, wherein the learned state is represented as a solid wooden block, learning state is represented as a colored block, and unknown state is represented as a transparent block.

14. The system of claim 9, wherein utilizing an algorithm to calculate incremental increases in the height of the knowledge structure, wherein the algorithm takes into account the number of academic questions answered by the user and the difficulty level of each question.

15. The system of claim 9, wherein the knowledge structure can be represented as a tower, a pyramid, or any suitable structure where blocks are aligned to show the inter-dependency of concepts.

16. The system of claim 9 further comprising:
a database for storing user details for individual users, state of mastery on educational concepts of each user, and interaction of the user with the knowledge structure.

17. A method for transforming a computer display into a dynamic knowledge structure representing hierarchical knowledge levels, achievements, and prerequisites that represent foundational knowledge to mastery of a knowledge concept, the method comprising:
executing code to cause a computer system to perform operations comprising:
accessing knowledge data that defines knowledge levels, wherein the knowledge levels represent a sequence of knowledge levels to reach mastery levels;
transforming an electronic display to visually present the knowledge levels as interconnected, layers of physical object representations, wherein the interconnections represent the prerequisite knowledge levels;
accessing personnel knowledge completion levels of a student;
causing appearances of the knowledge level physical objects representation that correspond to respective knowledge levels to be differentiated based on a state of mastery of corresponding knowledge levels by the student that inform the student of progress towards knowledge concept mastery and gaps in the foundational knowledge of the student of the knowledge concept mastery; and
adding interconnected, layers of physical object representations as the student reaches mastery of a knowledge level at a highest one of the layers.

18. The method of claim 17 wherein transforming the display to visually present the knowledge levels as interconnected, physical objects comprises:
transforming the display to visually present the knowledge levels as interconnected, 3-dimensional blocks in a tower of blocks, wherein each block that is positioned lower than a higher block is a prerequisite to the higher block.

19. The method of claim 17 wherein causing appearances of the knowledge level physical objects that correspond to respective knowledge levels to be differentiated based on a state of mastery of corresponding knowledge levels by the student comprises:
causing the appearances of the knowledge level physical objects corresponding to a state of non-mastered knowledge levels to be transparent; and
causing the appearances of the knowledge level physical objects corresponding to a state of mastered knowledge levels to be solid.

20. The method of claim 17 wherein causing appearances of the knowledge level physical objects that correspond to respective knowledge levels to be differentiated based on the state of mastery of corresponding knowledge levels by the student comprises:
causing the appearances of the knowledge level physical objects to increase in opacity as the student makes progress towards obtaining master of the knowledge level of the corresponding physical objects.

21. The method of claim 17 wherein accessing knowledge data that defines knowledge levels comprises:
accessing educational, common core curriculum data knowledge data that defines knowledge levels for knowledge topics by student grade level.

22. A system to transform a computer display into a dynamic knowledge structure representing hierarchical knowledge levels, achievements, and prerequisites that represent foundational knowledge to mastery of a knowledge concept, the system comprising:
one or more processors; and
a memory, coupled to the one or more processors, the memory including code that when executed by the one or more processors causes a computer system to perform operations comprising:
accessing knowledge data that defines knowledge levels, wherein the knowledge levels represent a sequence of knowledge levels to reach mastery levels;
transforming an electronic display to visually present the knowledge levels as interconnected, layers of physical object representations, wherein the interconnections represent the prerequisite knowledge levels;
accessing personnel knowledge completion levels of a student;
causing appearances of the knowledge level physical objects representation that correspond to respective knowledge levels to be differentiated based on a state of mastery of corresponding knowledge levels by the student that inform the student of progress towards knowledge concept mastery and gaps in the foundational knowledge of the student of the knowledge concept mastery; and
adding interconnected, layers of physical object representations as the student reaches mastery of a knowledge level at a highest one of the layers.
